(19) United States
(12) Patent Application Publication
(10) Pub. No.: US 2021/0381236 A1
(43) Pub. Date: Dec. 9, 2021

(54) Composite Wall Panel and System

(71) Applicant: Jack DeWayne Rigsby, II, Grantsburg, IL (US)

(72) Inventor: Jack DeWayne Rigsby, II, Grantsburg, IL (US)

(73) Assignee: Thaddeus, Inc., San Jose, CA (US)

(21) Appl. No.: 17/341,366

(22) Filed: Jun. 7, 2021

Related U.S. Application Data
(60) Provisional application No. 63/035,264, filed on Jun. 5, 2020.

(51) Int. Cl. E04C 2/04; B28B 23/04

(52) U.S. Cl. CPC E04C 2/044; B28B 23/04

(57) ABSTRACT

A precast concrete wall panel and system comprising pre-stressed concrete layers surrounding an insulation layer, the concrete layers prestressed using fiber reinforce polymer bar rebar.

### CROSS-REFERENCE TO RELATED APPLICATIONS

This application claims the benefit of U.S. Application No. 63/035,264, filed on Jun. 5, 2020, by the present inventors, entitled “Precast Concrete Wall Panel System Utilizing Prestressed Composite Reinforcement,” international application No. PCT/US2017/056000, filed on Oct. 10, 2017, entitled “Production of Pre-Stressed Concrete Structures Using Fibrous Reinforcing Tendons,” U.S. application Ser. No. 16/375,260, filed on Apr. 4, 2019, entitled “Production of Pre-Stressed Concrete Structures Using Fibrous Reinforcing Tendons,” and U.S. Application No. 62/406,613, filed on Oct. 11, 2016, entitled “Concrete Pre-Stressed with Fiber Reinforced Polymers,” which both are hereby incorporated by reference in their entirety for all allowable purposes, including the incorporation and preservation of any and all rights to patentable subject matter of the inventor, such as features, elements, processes and process steps, and improvements that may supplement or relate to the subject matter described herein.

### STATEMENT REGARDING FEDERALLY SPONSORED RESEARCH OR DEVELOPMENT

Not Applicable

### BACKGROUND OF THE INVENTION

The present invention relates to the production of pre-stressed concrete, and in particular to the production of a composite wall panel using pre-stressed concrete with fibrous reinforcing tendons.

Modern use of steel reinforcement, known as rebar, concealed within the concrete to carry the loads and protect the rebar from the environment. Steel is made mainly of iron, and one of iron's unalterable properties is that it rusts. This ruins the durability of concrete structures in ways that are difficult to detect and reduces the longevity of the structure causing costly to repair.

The first defense against rebar corrosion is to thicken the highly impermeable concrete coverage. This limits the amount of square footage that can be transported at one time due to highway load limitations. It also creates a need for large cranes to move the panels. It requires substantial foundations, beams and columns to carry the dead load created by these concrete panels. Current prestressed concrete walls panels using steel reinforcement cables and rebars are heavy due to required cover over and the weight of steel reinforcement.

### SUMMARY OF THE INVENTION

Current usage of composite rebar reinforcement without our prestress technology is not cost efficient due to the low modulus of elasticity of typically used composite reinforcement, with the exception of carbon fiber composite rebar which has a limitation of being too costly for use except in very specialized applications. Typical composite rebar currently used such as glass fiber rebar with the low modulus stretches much easier than steel rebar. This creates a need to use more rebar to compensate or the panels must be designed with larger diameter rebar to avoid cracking the panels during transport or erection.

Using prestressed composite reinforcement allows for thinner wall sections reducing the weight of the wall panels. Panels can be designed with sections to bear the loads required without having to design the sections to prevent reinforcement from corrosion.

### BRIEF DESCRIPTION OF THE DRAWINGS

FIG. 1 is a schematic illustration of a portion of an exemplary composite wall panel according to the present invention.

FIG. 2 is schematic bottom view of a cross sectional width of the composite wall panel in FIG. 1 cut at line A-A.

FIG. 3 is schematic side view of a cross sectional height of the composite wall panel in FIG. 1 cut at line B-B.

FIG. 4 is an illustration of an exemplary chuck and stressing system.

FIG. 5 is an exemplary flow diagram for a process for making a composite wall panel according to the present invention.

### DESCRIPTION OF THE PREFERRED EMBODIMENT

As stated above, current steel reinforced prestressed concrete wall panels are designed to protect the steel reinforcement inside of the concrete sections as opposed to being designed to carry the loads they are subject to. This limits the amount of square footage that can be transported at one time due to highway load limitations. It also creates a need for large cranes to move the panels. It requires substantial foundations, beams and columns to carry the dead load created by these concrete panels.

Current usage of composite reinforcement without our prestress technology is not cost efficient due to the low modulus of elasticity of typically used composite reinforcement, with the exception of carbon fiber composite which has a limitation of being too costly for use except in very specialized applications. Typical composite rebar currently used such as glass fiber rebar with the low modulus stretches much easier than steel rebar. This creates a need to use more rebar to compensate or the panels must be designed with larger diameter rebar to avoid cracking the panels during transport or erection. The invention claimed here solves this problem.

Prestressing the composite reinforcement rebar in the concrete panels creates a compression in the concrete from the prestressed rebar which creates a stiffer panel than non-stressed rebar. The increased in tensile strength allows us to increase the distance between rebar. Composite rebars do not rust allowing us to decrease concrete coverage, decrease in concrete volume and bring the composite rebar closer to the surface of the wall panel allowing the load to be absorb by the rebars sooner than steel rebars. Composite reinforcement may herein be referred to as Fiber Reinforced Polymer or FRP. “Rod rebar” may be used to specifically refer to non-twisted composite rebar.

This allows for more panels to be transported to construction sights, smaller cranes to be used to move the panels and reduced beam, column and foundation costs due to the decreased dead load of the panels.

The claimed invention differs from what currently exists. Our prestressed composite concrete panels are lighter and more durable than conventional steel strands/cables prestressed concrete panels. Our panels are also less costly to produce, transport and erect due to the reduction in concrete used.

Current prestressed wall panels are expensive to transport and erect due to the weights and equipment needed to move such weights and are mainly limited to commercial construction due to these factors.

Also, it can produce Wall panels can be produced for use in underground, above ground structures or near salty atmosphere like oceans and seas. Wall panels can be structural or curtain wall and/or architectural.

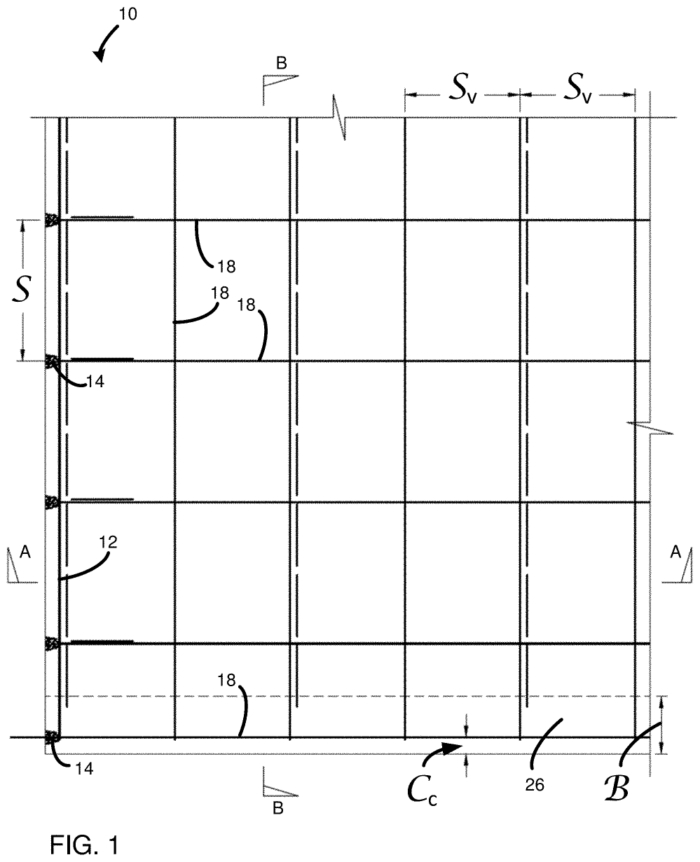

Referring now also to FIGS. 1 through 3, an exemplary embodiment of a composite wall panel 10 is shown to have a framework of rod rebar 18 within a bulkhead 12 form. In the exemplary embodiment, horizontal rod rebar 18 are shown spaced distance S apart. In the exemplary embodiment, vertical rebar 18 are optionally shown spaced a distance Sᵥ apart. In the exemplary embodiment, spaced distance S may appropriately be about 12 inches, and suitably 9 inches to 18 inches, and distance Sv may appropriately be about 10 inches, and suitably 6 inches to 18 inches. A bond beam 26 is shown at the base of the exemplary embodiment. The exemplary bond beam has a thickness B. A suitable bond beam thickness B may 4 inches to 18 inches, with the exemplary embodiment being 6 inches. Bond beam 26 is also shown to have a concrete cover thickness C_{c}. The concrete cover thickness C_{c} is an amount of concrete needed to cover the rod rebar 18. The concrete cover thickness C_{c} may be adequate to prevent cracking of the concrete when the concrete 20 is set and the rod rebar 18 holds the tension. Concrete cover thickness C_{c} may be greatly reduced because of the rod rebar 18 being made of composite rebar.

In the exemplary embodiment, the rod rebar 18 may be basalt fiber reinforced polymer, also known in the trade name “Rockbar”, by Galen Composites. The rod rebar 18 may be solid fiber reinforced polymer, as can be contrasted by twisted fiber filament rods.

Chucks 14 are shown to be positioned outside bulkhead 12 and operatively attached to selected rod rebar 18. Chuck 14 are designed to allow rod rebar 18 to be drawn outwardly through the chuck 14, while then holding the rod rebar 18 firmly in place, and not allowing retraction. Appropriately sized and designed chuck 14 should be able to hold in excess of a ton of tension on a piece of rod rebar 18.

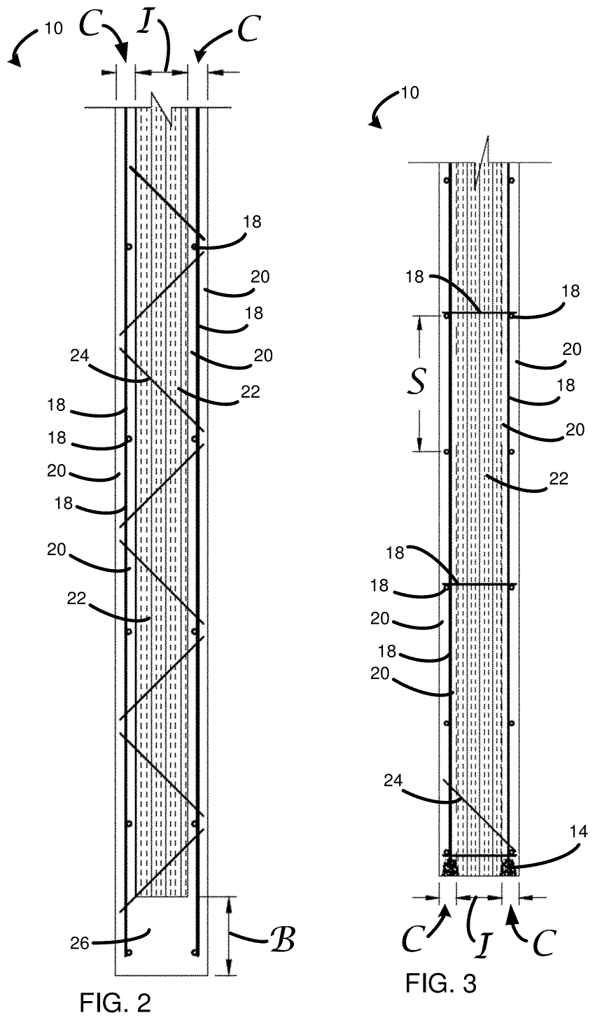

Referring now primarily to FIGS. 2 and 3 an exemplary composite wall panel may be constructed of a layer of insulation 22 sandwiched between layers of prestressed concrete 20. In the exemplary embodiment the concrete layers are shown to have a concrete thickness C and the insulation have an insulation thickness I. Concrete thickness C may range from one quarter inch to 3 inches, with the exemplary embodiment being approximately 1.5 inches. Insulation thickness I may range from an inch to 12 inches, with the exemplary embodiment being 4 inches.

In the exemplary embodiment, a rod rebar 18 is embedded with in concrete 20 in each layer of concrete 20 with in wall panel 10. Shear connectors 24, which may be made of similar material to the rod rebar 18, may be placed diagonally through the wall panel 10 structure to provide shear strength. Shear connectors 24 that do not conduct heat may be advantageous in maintaining the high insulation factor of the composite wall panel 10.

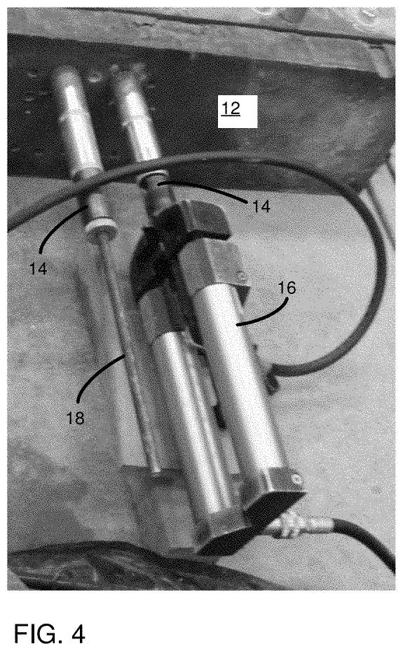

Referring now to FIG. 4, an exemplary stressing ram 16 is shown engaged on a piece of rebar 18. A tensioning chuck 14 is shown intermediate the stressing ram 16 and the bulkhead 12. And appropriate stressing ram 16 must be able to apply in excess of a ton of tension pressure to the rebar 18. An appropriate chuck 14 must be able to grip and hold the rebar 18 at substantial tension without damaging the rod rebar 18.

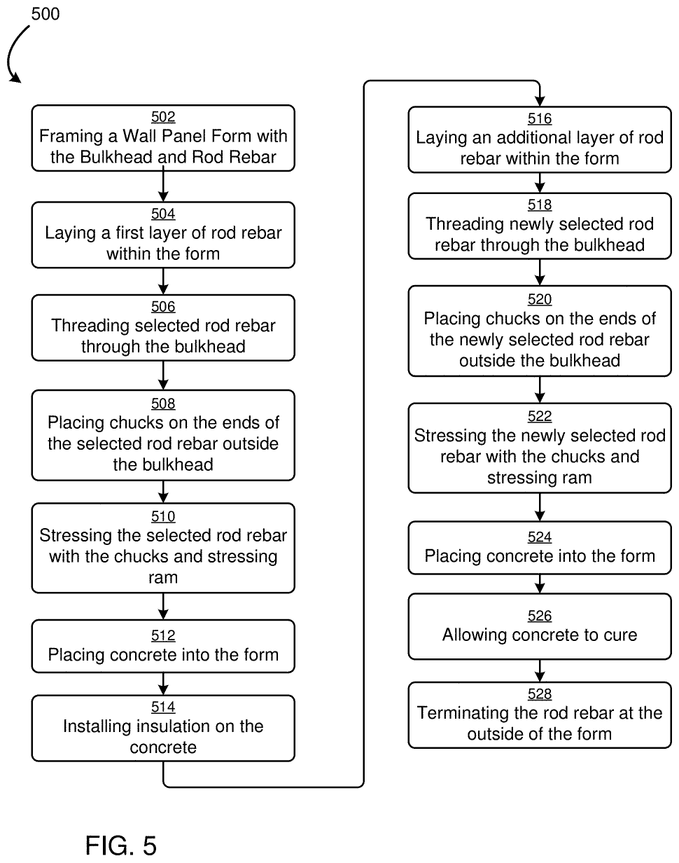

Referring now to FIG. 5, an exemplary process for forming a composite panel 500 is provided. The exemplary process may start with framing 502 a wall panel 10 form with the bulkhead 12 and rod rebar 18, and then proceed as follows. Laying 504 a first layer of rod rebar within the form. Threading 506 selected rod rebar through the bulkhead. Placing 508 chucks on the ends of the selected rod rebar outside the bulkhead. Stressing 510 the selected rod rebar with the chucks and stressing ram. Placing 512 concrete into the form. Installing 514 insulation on the concrete. Laying 516 an additional layer of rod rebar within the form. Threading 518 newly selected rod rebar through the bulkhead. Placing 520 chucks on the ends of the newly selected rod rebar outside the bulkhead. Stressing 522 the newly selected rod rebar with the chucks and stressing ram. Placing 524 concrete into the form. Allowing 526 concrete to cure. Terminating 528 the rod rebar at the outside of the form. It can be appreciated that the bulkhead 12 and chucks 14 may be reused.

Once formed, composite wall panels 10 may be used horizontally as floor or ceiling panels, in addition to their conventional use as vertical walls. Being that the amount of concrete is greatly reduced, while retaining strength and rigidity, the composite wall panels may be easily formed at a centralized location and shipped to a use site.

Using prestressed composite precast concrete wall panels manufacturers are able to use less concrete and eliminating the steel in their production reducing overall cost and weight. Builders are able to transport more wall panels to the construction site. Smaller cranes can be used to move the panels or larger cranes can extend their reach without having to move as often. The reduced dead load of the panels generally reduces the cost of the foundation. Additionally, this invention can be used to produce any item that is currently now produced using prestressed steel strand and concrete. Items could include but are not limited to beams and columns, railroad sleepers, seawalls, infrastructures, parking lot, podiums, bridge decks and double-T parking decks. Also, it can create: Wall panels can be produced for use in underground or above ground structures. Wall panels can be structural or curtain wall and/or architectural.

The examples contained in this specification are merely possible implementations of the current system, and alternatives to the particular features, elements and process steps, including scope and sequence of the steps may be changed without departing from the spirit of the invention. The present invention should only be limited by the examined and allowed claims, and their legal equivalents, since the provided exemplary embodiments are only examples of how the invention may be employed, and are not exhaustive.

I claim:

1. A composite precast wall panel, comprising:
a thickness of insulation sandwiched between concrete layers; and
concrete layers comprising prestressed composite reinforcement tendons and a thickness of concrete to receive composite reinforcement tendon compression stress and cover the composite reinforcement tendons without cracking under prestress tension.

2. The composite precast wall panel of claim 1, wherein:
thickness of insulation is about 4 inches; and
the concrete layers are each about 1.5 inches thick.

3. The composite precast wall panel of claim 2, wherein:
the composite reinforcement tendons are non-twisted composite reinforcement rods, about 0.118 inches in diameter.

4. The composite precast wall panel of claim 3, wherein:
the solid non-twisted composite reinforcement rods are comprised of material selected from the group consisting of basalt fibers, carbon fibers, polymeric fibers, glass fibers and mixtures thereof.
